(19) United States
(12) Patent Application Publication
(10) Pub. No.: US 2022/0354142 A1
(43) Pub. Date: Nov. 10, 2022

(54) CARBONATED YOGURT DRINK AND MANUFACTURING METHOD

(71) Applicant: Justin Bijan KANGARLOO, Calgary (CA)

(72) Inventor: Justin Bijan KANGARLOO, Calgary (CA)

(21) Appl. No.: 17/736,984

(22) Filed: May 4, 2022

Related U.S. Application Data
(60) Provisional application No. 63/183,908, filed on May 4, 2021.

(30) Foreign Application Priority Data
May 4, 2021 (CA) 3117000

(51) Int. Cl. A23C 9/13

(52) U.S. Cl. CPC A23C 9/1307; A23C 2240/20; A23Y 2220/49

(57) ABSTRACT

A method for producing a carbonated yogurt drink, according to one aspect, includes mixing Greek yogurt in the range of 40 to 75 parts; liquid milk in the range of 60 to 25 parts; and fruit puree in the range of 0 to 15 parts to create a yogurt emulsion. The yogurt emulsion is transferred to a pressurizable vessel and dry ice of approximately 0.5% by weight of the yogurt emulsion is added to the vessel. The vessel is sealed and refrigerated for up to seven days during which the CO₂ is absorbed by the yogurt emulsion. The pressurizable vessel may be, for example, an aluminum drink can or other suitable pressurized beverage container.

### CROSS-REFERENCE TO RELATED APPLICATIONS

This application claims the benefit of U.S. Provisional patent application No. 63/183,908 and Canadian patent application no. 3,117,000, both filed on May 4, 2021 and entitled “Carbonated Yogurt Drink”, all of which are incorporated herein by reference.

### FIELD

The present disclosure relates to carbonated yogurt drinks and the manufacture thereof; in particular, the present disclosure relates to the manufacture of carbonated yogurt drinks including the step of carbonation of the drink in-situ.

### BACKGROUND

Carbonated yogurt beverages are known in some countries and cultures. For example, Applicant is aware of a Persian drink called Doogh. Doogh is carbonated water mixed with predominantly yogurt, salt and mint. Doogh is primarily geared towards the Middle Eastern or Iranian markets and is generally not appreciated by the North American palate.

In the prior art, Applicant is aware of U.S. Pat. No. 5,624,700 to Ogden. Ogden discloses a method for carbonating a solid or semi-solid, spoonable food.

Carbonation of a yogurt beverage presents challenges. For example, the ingredients included in traditional carbonated beverages, such as soft drinks or sparkling water beverages, are water-based and may include additives such as flavouring, colour and/or sweetener, including sugar or artificial sweeteners. Such beverages are carbonated by injecting carbon dioxide gas into the liquid beverage under pressure. In contrast, yogurt has a higher viscosity than water, and tends to stick to lines, valves, and other manufacturing equipment, which may make the equipment more difficult to clean. Additionally, to the Applicant's knowledge, the direct carbonation of a yogurt-containing beverage under pressure using gaseous carbon dioxide presents the challenge of causing the carbonated yogurt to froth and bubble up, causing spillage and making it difficult to transfer the carbonated yogurt beverage to individual beverage vessels for sale to a consumer. Furthermore, to the Applicant's knowledge, it may be difficult to introduce and maintain a desired level of carbonation in yogurt-containing beverages. Such challenges may make it difficult to manufacture carbonated yogurt-containing beverages using the same equipment and processes as for manufacturing water-based carbonated beverages.

An additional challenge presented by producing carbonated yogurt beverages, is to manufacture a carbonated yogurt beverage that is shelf-stable for a commercially reasonable period of time. To the Applicant's knowledge, an issue often encountered with carbonated yogurt beverages is that the whey, contained in yogurt, may separate after a period of time. Whey separation may result in a watery layer forming within the beverage vessel, and produces the undesirable quality of a water-like layer sitting on top of the thicker, yogurt layer of the beverage. To the Applicant's knowledge, the issue of whey separation may have been addressed in the past by homogenizing the mixture of yogurt, milk and fruit, flavouring or other additives under pressure, prior to carbonating the mixture. However, the step of homogenizing the yogurt mixture under pressure, for example in the range of 30-180 bar, requires access to specialized homogenizing equipment.

Yogurt-based beverages tend to be more viscous than water-based beverages. As a result, yogurt-based beverages, depending on their specific composition, may be more difficult to pour out of a container or more difficult to drink directly from a container, in the case of single-serving beverage vessels. Due to the higher viscosity, it may be particularly difficult to pour yogurt-based beverages out of beverage vessels that have standard sized openings, such as standard sized openings on drink bottles or drink cans. To the Applicant's knowledge, while there exists wide mouth openings or full aperture openings on drink vessels, there does not appear to be a pressurizable drink vessel having a wide mouth or a full aperture opening that is commercially available to consumers.

### SUMMARY

The present disclosure provides a method for producing a carbonated yogurt drink or beverage that is more to the North American taste and preference, by producing a drink that is creamy, sweet and/or fruity, rather than watered-down and salty. Additionally, manufacturing carbonated yogurt beverages in accordance with the methods disclosed herein, in one aspect, may provide a yogurt beverage with an ideal level and character of carbonation that consumers may find pleasing on the tongue and which may enhance the refreshing quality of the beverage. Surprisingly, the Applicant has discovered a simplified manufacturing method which produces a carbonated yogurt beverage that has an ideal level of carbonation, is shelf-stable under refrigeration for six months, and which contains relatively high levels of protein and live lactic acid bacteria sufficient for acting as a probiotic. In some embodiments, advantageously, the manufacturing methods disclosed herein do not require specialized equipment and are scalable.

In one aspect of the present disclosure, a method for preparing a carbonated yogurt beverage comprises the following steps:
a. preparing a yogurt emulsion by mixing together a set of ingredients, wherein when the prepared yogurt emulsion consists of 100 parts, the set of ingredients consists of: Greek yogurt in the range of 40 to 75 parts; liquid milk in the range of 60 to 25 parts; and fruit puree in the range of 0 to 15 parts;
b. transferring the prepared yogurt emulsion to one or more pressurizable vessels so as to fill each pressurizable vessel with yogurt emulsion to a filled volume that is less than a total volume of each said pressurizable vessel;
c. adding solid CO₂ to the yogurt emulsion in the one or more pressurizable vessels, wherein the CO₂ does not exceed 0.5% by weight of the total weight of the yogurt emulsion in a pressurizable vessel and then sealing the one or more pressurizable vessels;
d. storing the emulsion in the sealed, pressurizable vessels at an anti-spoilage temperature for up to seven days until the solid CO₂ is absorbed by the yogurt emulsion in gaseous form.

In some embodiments, the set of ingredients of the prepared yogurt emulsion consists of: 54 parts Greek yogurt, 36 parts liquid milk and 10 parts fruit puree. In other embodiments, the set of ingredients of the prepared yogurt emulsion consists of: 75 parts Greek yogurt and 25 parts liquid milk. Regarding the amounts of solid CO₂ added to the yogurt emulsion, in some embodiments the solid CO₂ is approximately 0.25% by weight of the total weight of the yogurt emulsion in each said pressurizable vessel. In other embodiments, the amount of solid CO₂ is in the range of 0.2% to 0.35% by weight of the total weight of the yogurt emulsion in each said pressurizable vessel. The filled volume of the yogurt emulsion within the pressurizable vessel may be approximately 90% of the total volume of each pressurizable vessel. In some embodiments, the step of adding solid CO₂ to the yogurt emulsion is performed within four hours of preparing the yogurt emulsion.

In some embodiments, each said pressurizable vessel may be selected from a group comprising: aluminum drink can, tin drink can, glass drink bottle, plastic drink bottle. Where the pressurizable vessel is an aluminum drink can, the capacity of the aluminum drink can may be 237 mL or 355 mL. In one aspect, the sealed opening of the pressurizable vessel is preferably a wide mouth sealed opening.

In another aspect, the sealed pressurizable vessels may be agitated prior to the step of storing the sealed pressurizable vessels so as to complete absorption of the CO₂ by the yogurt emulsion in less than seven days. Also, the sealed pressurizable vessels may be stored at the anti-spoilage temperature of below 4° C. and above 0° C. so as to complete absorption of the CO₂ by the yogurt emulsion in less than seven days. In some embodiments, the anti-spoilage temperature is equal to or less than 4° C. In some embodiments, all of the steps of the method are performed at a temperature within the range of 0° to 10° C. In some embodiments, the fruit puree may comprise: fruit, water, pectin and sweetener.

A carbonated yogurt beverage produced by any of the methods disclosed or claimed herein is provided. In some embodiments, a carbonated yogurt beverage produced by the methods disclosed or claimed herein comprises live lactic acid bacteria. In one embodiment, where the yogurt emulsion is prepared by mixing together 54 parts Greek yogurt, 36 parts liquid milk and 10 parts fruit puree and the solid CO₂ added to the emulsion is approximately 0.25% of the weight of the yogurt emulsion, the resulting beverage contains an original amount of live lactic acid bacteria at the time of manufacture, and contains at least 10% of the said original amount of live lactic acid bacteria after the beverage has been stored for a period of six months at or below 4° C. In this resulting beverage, the original amount of live lactic acid bacteria is equal to or greater than 10⁹ cfu in a single serving of said beverage.

### DETAILED DESCRIPTION

### Preparation of Yogurt Emulsion

In one aspect of the present disclosure, a simplified, scalable method for preparing a carbonated yogurt beverage is provided. The method includes the step of preparing a yogurt emulsion, which is a mixture of the different ingredients included in the yogurt beverage prior to carbonation. For example, the yogurt emulsion is prepared by mixing together Greek yogurt, liquid milk (such as skim milk), and optionally, a fruit puree or other flavouring additives, in particular ratios. The mixing is accomplished, for example, by using a food blender, processor or mixer, to produce a uniform mixture of the combined ingredients, the mixing performed at ambient pressure and without using specialized homogenizing equipment. As used herein, the term “Greek yogurt” refers to strained yogurt, in which the yogurt has been strained to remove most or all of its whey, resulting in a thicker consistency compared to unstrained yogurt. The terms “Greek yogurt” and “strained yogurt” are used interchangeably throughout this disclosure.

Advantageously, the Applicant has discovered that using strained yogurt as the base for the yogurt emulsion produces a shelf stable carbonated beverage which is not susceptible to product separation. The Applicant has found that using strained yogurt produces a carbonated yogurt beverage that does not separate into different layers, even after being stored for a period of up to six months after the manufacturing date. This is the case even in the absence of homogenizing the mixture of strained yogurt, milk and optional flavouring ingredients, which homogenizing step, in the Applicant's view, is typically used in the manufacture of other carbonated yogurt products.

In some embodiments, the yogurt emulsion is made with skim milk, although this is not intended to be limiting and it will be appreciated that milk with different fat contents may also be used and are intended to be included in the scope of the present disclosure. Furthermore, the liquid milk may also include liquid milk reconstituted from milk powder mixed with water or other liquids.

The fruit puree or other flavouring additives (hereinafter, collectively referred to as “fruit puree”), which is an optional ingredient, may include, but is not limited to: blended or pureed fruit, sweetener, pectin and/or citric acid and/or concentrated lemon juice. The sweetener may include sugar in any form, and/or artificial sweeteners, and/or natural, non-sugar sweeteners, such as stevia, as would be known to a person skilled in the art. The foregoing example list of ingredients included in the fruit puree is not intended to be limiting, and it will be appreciated that other ingredients, including but not limited to natural or artificial flavourings, stabilizers, preservatives, etc. may also be included in the fruit puree ingredient. Furthermore, it will be appreciated that the set of ingredients for the yogurt emulsion is not limited to containing Greek yogurt, liquid milk and the optional fruit puree, and may include other ingredients for enhancing the flavour, texture, shelf life and other characteristics of the carbonated yogurt beverage, as would be known to a person skilled in the art. However, advantageously and as will be further explained in the Examples provided below, the Applicant has found that carbonated yogurt beverages that are shelf stable for up to six months at a temperature in the range of 4° C. to above 0° C., and may be produced following the methods disclosed herein that only consist of the following ingredients: Greek yogurt, skim liquid milk, carbon dioxide and fruit puree comprising pureed fruit, sugar, water and pectin. In some embodiments, in a yogurt emulsion consisting of 100 parts, the set of ingredients are mixed together in the following ratios: Greek yogurt, in the range of 40 to 75 parts; liquid milk, in the range of 60 to 25 parts; and fruit puree, in the range of 0 to 15 parts.

Pressurizable Vessels

Once the yogurt emulsion is prepared, it is transferred to or contained in a pressurizable vessel for the in-situ carbonation step. In some embodiments, the pressurizable vessel or vessels may be any type of drink container that is capable of withstanding and containing internal pressures of up to 90 psi. Examples of such drink containers include, but are not limited to, aluminum drink cans, tin drink cans, plastic drink bottles or glass drink bottles. In some embodiments, the pressurizable vessels may also include bright tanks, kegs, or any other pressurizable vessel that is capable of withstanding pressures up to or exceeding 90 psi and which may be used in industrial food and beverage manufacturing facilities, as would be known to a person skilled in the art. In a preferred embodiment, the pressurizable vessels include aluminum drink cans with a capacity of 237 mL or 355 mL, which are suitable for a single serving of the carbonated yogurt beverage.

Some advantages of aluminum cans include, but are not limited to, their ease of storage and transportation, and that such vessels shield the carbonated yogurt beverage from light, which may assist in prolonging the shelf life of the product. Additionally, aluminum drink cans typically include an opening tab, which is pulled upwardly on one end to press the opposite end of the tab into a portion of the can end, thereby pushing a scored portion of the can end inwardly towards the interior of the can to thereby unseal the sealed opening of the can and provide access to the beverage contained therein. This pull tab method of unsealing the pressurized drink can provides the advantage of controlling the rate of unsealing, which allows a consumer to slowly release some of the pressure from the can during opening and thereby avoid spontaneous foaming or spilling of the carbonated beverage.

Pressurizable vessels which are sized for containing one or more servings of the beverage and which are used to package the beverage for the consumer, will have a sealed opening that is unsealed by the consumer to access the beverage. In a preferred embodiment, the Applicant finds that it is preferable for the sealed opening to have a wide mouth which may allow ease of pouring the beverage or consuming the beverage directly from the vessel, given that the carbonated yogurt beverage may have a higher viscosity than water-based beverages. Examples of wide mouth sealed openings include, but are not limited to, full aperture aluminum can ends, whereby the full aperture sealed opening, when opened, extends across substantially most or all of the total surface area of the can end, and wide mouth glass bottle openings.

In other preferred embodiments, the pressurizable vessels of any type may be suitable for containing a single serving of the carbonated yogurt beverage, as the Applicant has observed that the beverage tends to lose carbonation within approximately one or two hours after the pressurizable vessel is opened, and as such, it is desirable to consume the product within a couple of hours or so after the pressurizable vessel has been opened. However, it will be appreciated that the examples of the size of the vessel provided herein are not intended to be limiting, and that pressurizable vessels of any size may be used and are intended to be included in the scope of the present disclosure.

When transferring the yogurt emulsion to the one or more pressurizable vessels, each pressurizable vessel is filled to a volume that is less than a total volume of the pressurizable vessel, to leave some head space inside the can that may allow for slight expansion of the carbonated yogurt emulsion after the vessel has been sealed. For example, when the vessel is filled with the yogurt emulsion, the yogurt emulsion may occupy approximately 90% of the vessel's total volume. It will be appreciated that the term “approximately”, as used in this paragraph, means 90% plus or minus 5% of the vessel's total volume.

In Situ Carbonation

Once the yogurt emulsion is prepared and then either contained in, or transferred to, one or more pressurizable vessels, the yogurt emulsion is carbonated by adding solid carbon dioxide (otherwise referred to herein as “dry ice”) directly to the pressurizable vessel, and then sealing the pressurizable vessel and storing the vessel for a period of time. During this storage period, the dry ice sublimates to disperse the resulting gaseous carbon dioxide throughout the yogurt emulsion, until the carbon dioxide is absorbed by the yogurt emulsion. In a preferred embodiment, a full amount of the carbon dioxide added to the pressurized vessel is completely absorbed by the yogurt emulsion. The Applicant has observed that during the first few days of storage, some of the carbon dioxide escapes the yogurt emulsion and is contained in the head space of the pressurized vessel, but over a period of time the gaseous carbon dioxide becomes completely absorbed in the yogurt emulsion.

The amount of dry ice added to the yogurt emulsion does not exceed 0.5% by weight of the total weight of the yogurt emulsion in the pressurizable vessel. In some embodiments, the amount of dry ice is preferably in the range of 0.2% to 0.35% by weight of the total weight of the yogurt emulsion inside the vessel. The Applicant has found that dry ice within the range of 0.2% to 0.35% by weight of the total weight of the yogurt emulsion inside the vessel produces an ideal level of carbonation for the yogurt beverage, while at the same time allowing for a manufacturing tolerance to avoid exceeding 0.5% dry ice by weight of the total weight of the yogurt emulsion when precise instruments for measuring the dry ice are not available, as exceeding 0.5% dry ice may produce an excess of pressure inside the sealed vessel such that the vessel is unable to contain the pressure. In another preferred embodiment, the amount of dry ice is as close as possible to 0.5% by weight of the total weight of the yogurt emulsion inside the vessel, so long as the vessel is rated to withstand the internal pressure once the dry ice is added and the vessel is sealed, as the Applicant has found that this ratio of dry ice to yogurt emulsion produces an ideal level of carbonation for the yogurt beverage.

The carbonated yogurt beverage produced in accordance with the methods disclosed herein and in accordance with the illustrative Example provided below, having an ideal level and character of carbonation, has been described as having a light and airy texture, with a strong sensation of light fizzing on the tongue. The bubbles of CO₂ in solution with the yogurt emulsion are small and fine, which contributes to the pleasant texture and feel of the beverage and enhances the flavour profile of the beverage. The size of the CO₂ bubbles in the yogurt emulsion is smaller compared to the size of the CO₂ bubbles in, for example, a beer that has been carbonated via forcing CO₂ gas into the liquid under pressure; the smaller bubble size produced by the methods disclosed herein may be due to the method of carbonation in which solid CO₂ is introduced to the vessel, rather than forcing CO₂ gas through the yogurt emulsion. Applicant has found that exceeding 0.5% dry ice added to the yogurt emulsion may produce a beverage that is too gassy and which bubbles up too quickly when the vessel is unsealed, which may cause the beverage to flow uncontrollably out of the vessel and overpower the flavour of the beverage. Additionally, exceeding 0.5% dry ice by weight of the yogurt emulsion may result in an internal pressure of the sealed, pressurizable vessel that may be too high, thereby risking the vessel exploding open due to the excessive pressure of the CO₂.

Preferably, the dry ice is added to the yogurt emulsion within approximately four hours after the yogurt emulsion is prepared. the Applicant has found that if the yogurt emulsion is prepared more than four hours prior to the step of adding the dry ice, that the viscosity of the final product may be increased and therefore more difficult to pour. However, this is not intended to be limiting, and preparation methods which include refrigerating or storing the yogurt emulsion for a period of time exceeding four hours prior to adding the dry ice are intended to be included in the scope of the present disclosure.

After adding the dry ice to the vessel and sealing the vessel, the vessel may be stored for a period of time during which the carbon dioxide becomes completely absorbed by the yogurt emulsion. The Applicant has found that complete absorption of the carbon dioxide takes approximately seven days after the dry ice is added to the vessel when stored at approximately 4° C. However, the Applicant has found that shaking or agitating the vessel after sealing, and/or storing the vessel at temperatures less than 4° C., may reduce the amount of time it takes for the carbon dioxide to be fully absorbed by the yogurt emulsion.

The sealed vessel is stored at non-spoilage temperatures, which for example may be in the range of 0° C. to 4° C. or 4.5° C. However, a person skilled in the art will appreciate that the non-spoilage temperature may fall outside the range of 0° C. to 4.5° C. depending on whether any preservative agents or ingredients have been added to the yogurt emulsion, and that such other non-spoilage temperatures are intended to be included in the scope of the present disclosure for such yogurt emulsions.

As used herein, the term “approximately X % by weight”, which references the amount of dry ice to be added to the pressurizable vessel, is in recognition of the challenges in precisely measuring the weight of the dry ice that is transferred to the pressurizable vessel. This is because dry ice sublimates at −78.5° C., and since the yogurt emulsion would freeze at such a temperature, the step of adding dry ice to the yogurt emulsion is performed at a temperature of approximately 0° C. to 10° C. Thus, when the dry ice is removed from storage at temperatures lower than −78.5° C. it immediately begins to sublimate, and the weight of dry ice being measured for addition to the vessel is changing as the dry ice is transferred to the vessel. Thus, it will be appreciated that the term “approximately X % by weight” refers to a quantity of dry ice that is measured to be X % of the total weight of the yogurt emulsion at the time of measurement, plus or minus 0.05% by weight of the total weight of the yogurt emulsion, and that an unknown but small quantity of the measured quantity of dry ice may sublimate before the measured quantity of dry ice enters the vessel for absorption by the yogurt emulsion.

In some embodiments of the present disclosure, where the pressurizable vessel is a larger vessel used in the production of carbonated beverages, such as a bright tank or a keg, the yogurt emulsion may be mixed inside such vessels or transferred to such vessels after mixing, with the filled volume of the vessel less than the vessel's total volume (which, for example, may be 90% of the vessel's total volume). Thereafter, the dry ice is added to the yogurt emulsion, in an amount not exceeding 0.5% of the total weight of the yogurt emulsion, and then the vessel is sealed and maintained at a non-spoilage temperature for a period of time. The yogurt emulsion may be agitated with an agitator inside the vessel during this time period, to decrease the amount of time required for the CO₂ to be absorbed. Once the gaseous CO₂ is absorbed by the yogurt emulsion, the carbonated yogurt beverage may be packaged on a filling line under pressure, using techniques and equipment as would be known to a person skilled in the art.

Characteristics of the Carbonated Yogurt Beverage

In preferred embodiments, the carbonated yogurt beverages produced in accordance with the methods disclosed herein contain live lactic bacteria cultures, otherwise referred to or known as probiotics or yogurt cultures. It is known that such bacteria cultures confer health benefits when consumed, as these bacteria cultures are important to the support and maintenance of a healthy gut and digestion system. The amount of live lactic bacteria cultures sufficient to act as a probiotic, in some embodiments, is equal to or greater than 10⁹ cfu in one serving of the beverage, and in other embodiments the amount of live lactic bacteria sufficient to act as a probiotic will include amounts as are known to a person skilled in the art. Because the methods described herein do not require pasteurization of the carbonated yogurt beverages to remove harmful pathogens, the lactic bacterial cultures remain active.

Because a portion of the gaseous CO₂ is contained in the headspace of the filled vessel prior to sealing and before the CO₂ becomes absorbed in the yogurt emulsion, the Applicant theorizes that any oxygen is thereby evacuated upon sealing, creating an anaerobic environment in the sealed vessel which prohibits the growth of coliforms, E. Coli, yeast, mold or other pathogens. In some tests, the Applicant has observed that beverages produced in accordance with the methods disclosed herein may be stored at 4° C. for up to six months, without any detectible levels of the aforementioned pathogens in the beverage at six months. Advantageously, the same tests show that no material changes to the character of the carbonated yogurt beverage occurs after six months; in other words, limited or no separation of the beverage constituents occurs, no whey is observed to separate, and the beverage maintains a uniform consistency, after a storage period of six months. The beverage may have a pH between 4.3 to 4.6.

### Example 1

A yogurt emulsion was prepared by mixing the following ingredients together in a large mixing bowl, until a uniform consistency of the mixture was obtained:
15 L of Greek yogurt (containing 10% milk fat);
10 L of liquid skim milk;
2.8 L of raspberry fruit puree, the raspberry fruit puree comprising: water, raspberry puree, natural flavours and pectin.

Applicant observed that the resulting yogurt emulsion was creamy, smooth and pourable. The yogurt emulsion was then poured into several 237 mL aluminum cans (with the volume of yogurt emulsion being 215 mL or approximately 90% of the can's total capacity) and several 355 mL aluminum cans (with the volume of yogurt emulsion being 320 mL or approximately 90% of the can's total capacity). Then, approximately 0.5 g of dry ice was added to each 237 mL can and approximately 0.8 g of dry ice was added to the 355 mL can. As 0.5 g of dry ice is approximately 272 mL of gaseous CO₂ and 0.8 g of dry ice is approximately 436 mL of gaseous CO₂, this results in adding gaseous CO₂ that is approximately 1.27 and 1.36 the volumes, respectively, of the yogurt emulsion contained in the aluminum cans. Stated differently, the volumes of the yogurt emulsion prepared in this Example are, respectively, 226 g and 339 g, and therefore the weight of solid CO₂ is approximately 0.22% and 0.24%, respectively, of the weight of the yogurt emulsion in each aluminum can.

After the dry ice is added to the aluminum can, the aluminum can is immediately closed and sealed by seaming the can end onto the can. The sealed aluminum cans were then stored in a refrigerator at 4° C. for seven days. After seven days, the yogurt emulsion had fully absorbed the CO₂ and had a light, airy and complex texture. The carbonation, consisting of small bubbles, was felt on the tongue and provided a refreshing sensation.

The active lactic acid bacteria in the above finished beverages was found to be present in amounts of 1.6×10⁸ cfu/g when tested shortly after the seven day storage period. When samples from the same test batch were tested after six months storage at 4° C., the active lactic acid bacteria counts remained high, at 2.1×10⁷ cfu/g, which is approximately 13% of the active lactic acid bacteria counts tested shortly after the beverage was produced. Furthermore, shelf life testing conducted on the samples after six months of storage revealed no detectible levels of coliforms, E. Coli, yeast or mold. Finally, the samples retained a good taste profile and had not undergone any material changes after six months of storage (in other words, the beverage remained a uniform mixture with limited or no separation, and no separated whey was observed in the sample). This demonstrates the carbonated yogurt beverage produced in accordance with the methods described above have a shelf life of at least six months when stored at or below 4° C.

What is claimed is:

1. A method for preparing a carbonated yogurt beverage, the method comprising:
a. preparing a yogurt emulsion by mixing together a set of ingredients, wherein when the prepared yogurt emulsion consists of 100 parts, the set of ingredients consists of: Greek yogurt in the range of 40 to 75 parts; liquid milk in the range of 60 to 25 parts; and fruit puree in the range of 0 to 15 parts;
b. transferring the prepared yogurt emulsion to one or more pressurizable vessels so as to fill each pressurizable vessel with yogurt emulsion to a filled volume that is less than a total volume of each said pressurizable vessel;
c. adding solid CO₂ to the yogurt emulsion in the one or more pressurizable vessels, wherein the CO₂ does not exceed 0.5% by weight of the total weight of the yogurt emulsion in a pressurizable vessel and then sealing the one or more pressurizable vessels;
d. storing the emulsion in the sealed, pressurizable vessels at an anti-spoilage temperature for up to seven days until the solid CO₂ is absorbed by the yogurt emulsion in gaseous form.

2. The method of claim 1, wherein the set of ingredients of the prepared yogurt emulsion consists of: 54 parts Greek yogurt, 36 parts liquid milk and 10 parts fruit puree.

3. The method of claim 1, wherein the set of ingredients of the prepared yogurt emulsion consists of: 75 parts Greek yogurt, 25 parts liquid milk.

4. The method of claim 2, wherein the amount of solid CO₂ is approximately 0.25% by weight of the total weight of the yogurt emulsion in each said pressurizable vessel.

5. The method of claim 1, wherein the amount of solid CO₂ is in the range of 0.2% to 0.35% by weight of the total weight of the yogurt emulsion in each said pressurizable vessel.

6. The method of claim 1, wherein the filled volume of the yogurt emulsion within the pressurizable vessel is approximately 90% of the total volume of each pressurizable vessel.

7. The method of claim 1, wherein each said pressurizable vessel is selected from a group comprising: aluminum drink can, tin drink can, glass drink bottle, plastic drink bottle.

8. The method of claim 7, wherein the pressurizable vessel is an aluminum drink can, and wherein the capacity of the aluminum drink can is selected from a group comprising: 237 mL, 355 mL.

9. The method of claim 7, wherein a sealed opening of the pressurizable vessel is a wide mouth sealed opening.

10. The method of claim 1, wherein the step of adding solid CO₂ to the yogurt emulsion is performed within four hours of preparing the yogurt emulsion.

11. The method of claim 1, wherein the sealed pressurizable vessels are agitated prior to the step of storing the sealed pressurizable vessels so as to complete absorption of the CO₂ by the yogurt emulsion in less than seven days.

12. The method of claim 1, wherein the anti-spoilage temperature is equal to or less than 4° C.

13. The method of claim 1, wherein the sealed pressurizable vessels are stored at the anti-spoilage temperature of below 4° C. and above 0° C. so as to complete absorption of the CO₂ by the yogurt emulsion in less than seven days.

14. The method of claim 1, wherein the fruit puree comprises: fruit, water, pectin, sweetener.

15. The method of claim 1, wherein all of the steps are performed at a temperature within the range of 0° to 10° C.

16. A carbonated yogurt beverage produced by the method of claim 1.

17. A carbonated yogurt beverage produced by the method of claim 2, wherein the amount of solid CO₂ is approximately 0.5% by weight of a total weight of the emulsion in each said pressurizable vessel and wherein the carbonated yogurt beverage in the pressurizable vessel comprises an amount of live lactic acid bacteria sufficient to act as a probiotic.

18. The carbonated yogurt beverage of claim 17, wherein the beverage contains an original amount of live lactic acid bacteria at the time of manufacture and wherein the beverage contains at least 10% of the said original amount of live lactic acid bacteria after the beverage has been stored for a period of six months at or below 4° C.

19. The carbonated yogurt beverage of claim 18, wherein the original amount of live lactic acid bacteria is equal to or greater than 10⁹ cfu in a single serving of said beverage.
